(19) United States
(12) Patent Application Publication
(10) Pub. No.: US 2024/0070466 A1
(43) Pub. Date: Feb. 29, 2024

(54) Unsupervised Labeling for Enhancing Neural Network Operations

(71) Applicant: Bank of America Corporation, Charlotte, NC (US)

(72) Inventor: Matthew Murray, Roanoke, TX (US)

(21) Appl. No.: 17/900,103

(22) Filed: Aug. 31, 2022

(51) Int. Cl. G06N 3/08

(52) U.S. Cl. CPC G06N 3/088

(57) ABSTRACT

Systems, devices, and methods for improving neural network operations and accuracy are described. In an arrangement, the neural network may be applied for classifying input data to human-assigned labels. Training data being fed for training the neural network may be categorized in clusters (e.g., using a clustering algorithm). Training data and corresponding cluster identifiers may be used as test input and expected test output for the neural network, respectively. Neural network output from output nodes may then be mapped to the human-assigned labels.

### FIELD

Aspects described herein generally relate to the field of machine learning, and more specifically to improving neural network operations by applying unsupervised learning algorithms.

### BACKGROUND

Artificial neural networks constitute powerful machine learning algorithms that may be employed for a variety of computing tasks that require artificial intelligence. Artificial neural networks, inspired from biological neural networks, comprise interconnected artificial neurons. Each of the neurons may perform a processing function (e.g., apply a transformation/weight to an input signal) and transmit a generated output signal to a next neuron of the network for further processing. Neurons in a neural network are modeled in the form of layers, with neurons a layer receiving input from a previous layer and transmitting the output to a next layer of the network. Applications areas of neural networks are wide ranging and include control systems, pattern recognition, image recognition, data analysis, machine translation, finance, among many others.

Neural networks need to be “trained” prior to use for a specific application. Training a neural network comprises providing a training input to an input layer of the neural network, generating an output at an output layer of the neural network, comparing the generated output with an expected output for the training input, and modifying weights and biases associated with the neurons with the aim of matching (or at least reducing the error between) the generated output and the expected output. Generally, training data sets are provided by a user designing and/or using the neural network, and are dependent on specific applications for which a neural network is to be used for.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address various issues associated with training a neural network using a human labeled dataset. For example, the methods, devices, and systems described herein enable improved accuracy of a neural network by the use of unsupervised machine learning techniques for generating training datasets.

In accordance with one or more arrangements, a machine learning platform may comprise at least one processor; and memory storing computer-readable instructions that, when executed by the at least one processor, cause the machine learning platform to perform one or more operations. The machine learning platform may receive, from a training database, a training dataset comprising a plurality of inputs for a neural network. The machine learning platform may categorize, using a clustering algorithm, the plurality of inputs into a plurality of groups, wherein each of the groups is characterized by a group identifier. The machine learning platform may iteratively train, based on the plurality of inputs and group identifiers associated with the plurality of inputs, the neural network. The training may comprise: providing an input of the plurality of inputs, to a plurality of input nodes of the neural network, generating, from a plurality of output nodes, an output based on the input, determining an error value based on the output, a group identifier associated with the input, and a loss function, and based on the error value, modifying one or more model parameters of the neural network. The machine learning platform may map each of the plurality of output nodes of the neural network to corresponding user-assigned labels. The machine learning platform may send, to a user computing device, the model parameters of the neural network and the mapping between the plurality of output nodes of the neural network and the user-assigned labels.

In some arrangements, the neural network may be for classifying an input as corresponding to one of the user-assigned labels.

In some arrangements, the machine learning platform may remove groups which comprise a number of inputs less than a threshold quantity. In some arrangements, the machine learning platform may not use, for the training, groups which comprise a number of inputs less than a threshold quantity.

In some arrangements, the threshold quantity may be a fixed fraction of a quantity of the plurality of inputs.

In some arrangements, a dictionary data store may store a mapping between each of the group identifiers and corresponding user-assigned labels. The mapping each of the plurality of output nodes of the neural network to corresponding user-assigned labels may be based on the dictionary data store.

In some arrangements, the plurality of inputs may comprise machine-scanned handwritten characters and the user-assigned labels may comprise descriptions of the characters. In some arrangements, the plurality of inputs may comprise computer-readable bit patterns corresponding to the characters. In some arrangements, the plurality of inputs may comprise images and the user-assigned labels may comprise descriptions associated with the images.

In some arrangements, the loss function may be one of: a mean squared error loss function, a binary cross-entropy loss function; or a categorical cross-entry loss function.

In some arrangements, the clustering algorithm may comprise one or more of hierarchical clustering, centroid based clustering, density based clustering, or distribution based clustering.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for neural network training and operations, in accordance with one or more example arrangements;

FIG. 1B shows an example machine learning platform, in accordance with one or more example arrangements;

FIG. 2 shows a simplified example of an artificial neural network on which a machine learning algorithm may be executed, in accordance with one or more example arrangements;

FIG. 3 shows an example algorithm for training a neural network, in accordance with one or more example arrangements;

FIG. 4 show example training dataset input of some handwritten digits, in accordance with one or more example arrangements;

FIG. 5 show example training dataset input of some handwritten digits, in accordance with one or more example arrangements; and

FIG. 6 shows an example mapping between output nodes and human-assigned labels, in accordance with one or more example arrangements.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Machine learning technology relies on two overarching methods: supervised learning and unsupervised learning. Supervised learning enables a machine learning algorithm to draw on pre-conceived wisdom regarding data that is passed into it. For example, a machine learning algorithm using supervised learning may use labels assigned to input data (e.g., by a human) to train itself for categorizing any future input data. a machine learning algorithm using unsupervised learning uses unlabeled data for categorization and determine when an optimization is reached. This entails allowing for an optimal number of clusters to be found amongst the data without respect to pre-assigned labels as in supervised methods.

For example, a Modified National Institute of Standards and Technology (MNIST) dataset (e.g., comprising thousands of handwritten digits) may be used for training a supervised learning algorithm to identify handwritten digits. Each of the handwritten digits is associated with a pre-assigned label. That is, each image corresponding to a digit has its class assigned to it: ones assigned to the ‘1’ class, twos assigned to the ‘2’ class, etc.

However, while a single digit can be handwritten in multiple different styles (e.g., with a rightward slant, with a leftward slant), a pre-assigned label for all the different styles corresponds to only a single identifier (e.g., a ‘1’ or a ‘2’). For example, a ‘1’ that is a straight line (like: |) looks different from a ‘1’ with the slanted tip and horizontal line underneath itself (like: 1), but both are assigned the same label. Both are valid examples of how to draw a ‘1’, but both belong to the same label while being different in their pixel arrangement. This inconsistency may limit the accuracy of a neural network for identifying input digits by inconsistently identifying numbers written in different styles.

Various examples herein describe methods, devices, and systems for providing an improved architecture of a neural network to enhance neural network accuracy for categorization/identification problems. A two-stage algorithm is proposed whereby a first stage comprises an unsupervised algorithm for grouping training data and assigning labels to each of the groups. The labels may then be used as an expected output for training the neural network.

Passing all training data to an unsupervised algorithm (e.g., a clustering algorithm) enables usage of an optimal number of labels for training the neural network. This allows bridging the gap between what a human may interpret as a ‘1’ or a ‘2’ and what the machine interprets. When that unsupervised method reaches an optimality in accuracy, we can say that that's how many classes/groups should be allowed for this dataset. This allowance for computer versus human vision should enhance accuracy within image classification, essentially providing an edge over the current standard of simply running human pre-labeled data through an image recognition neural network.

With respect to the example of handwritten digit recognition, the purpose of the neural network is to provide a plain-English representation of the handwritten digits. That is, we want to be able to read back a handwritten image of a number as the number it's meant to represent. Therefore, the labels, corresponding to the training data, output from the clustering are each mapped to a human-assigned label (e.g., ‘1’, ‘2’, ‘3’, etc.). During operation, after neural network processing, the output from the output nodes may be remapped to human-assigned labels using a dictionary-defined mapping. The dictionary may be manually configured by a user based on clustering results of the training data.

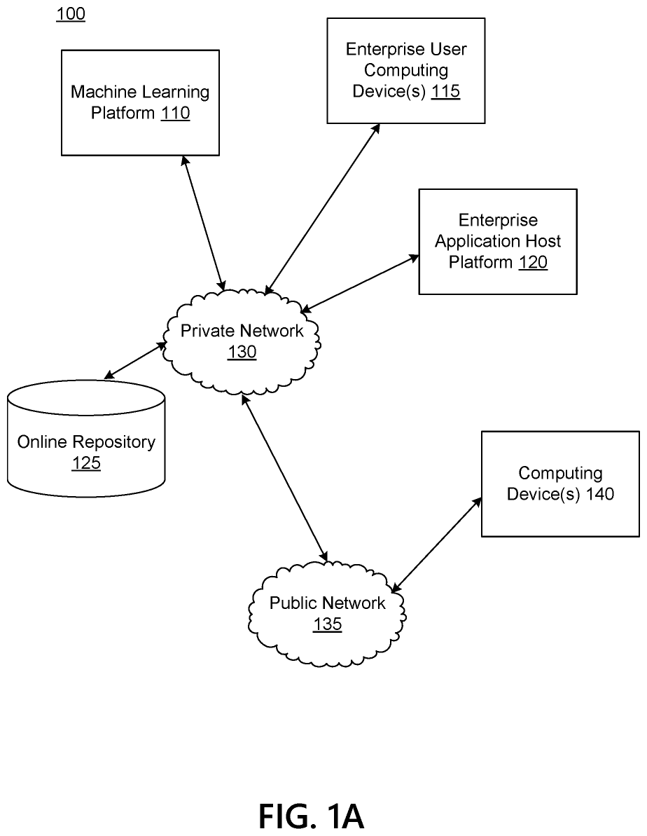

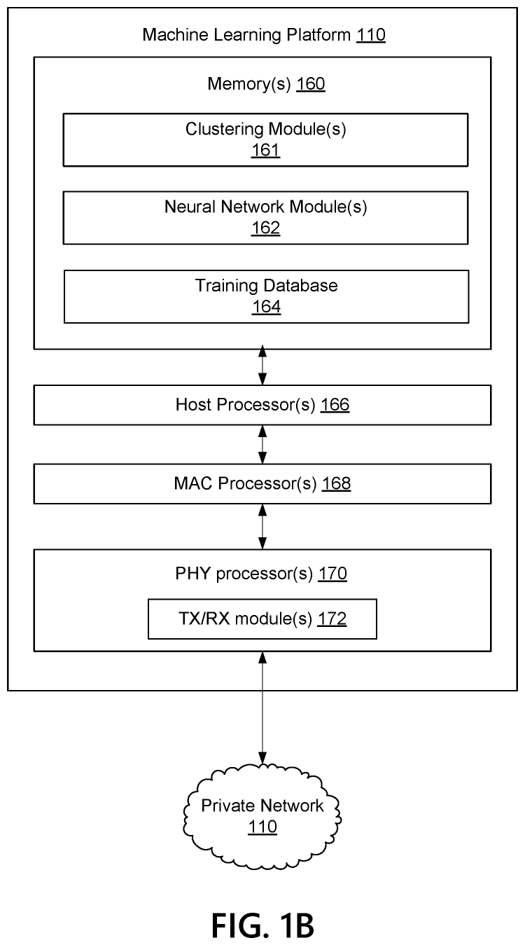

FIG. 1A shows an illustrative computing environment 100 for neural network training and operations, in accordance with one or more arrangements. The computing environment 100 may comprise one or more devices (e.g., computer systems, communication devices, and the like). The one or more devices may be connected via one or more networks (e.g., a private network 130 and/or a public network 135). For example, the private network 130 may be associated with an enterprise organization which may develop and support service, applications, and/or systems for its end-users. The computing environment 100 may comprise, for example, a machine learning platform 110, an online repository 125, one or more enterprise user computing device(s) 115, and/or an enterprise application host platform 120 connected via the private network 130. Additionally, the computing environment 100 may comprise one or more computing device(s) 140 and an online repository 125 connected, via the public network 135, to the private network 130. Devices in the private network 130 and/or authorized devices in the public network 135 may access services, applications, and/or systems provided by the enterprise application host platform 120 and supported/serviced/maintained by the machine learning platform 110.

The devices in the computing environment 100 may transmit/exchange/share information via hardware and/or software interfaces using one or more communication protocols over the private network 130 and/or the public network 135. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), and the like).

The machine learning platform 110 may comprise one or more computing devices and/or other computer components (e.g., processors, memories, communication interfaces) configured to perform one or more functions as described herein. Further details associated with the architecture of the machine learning platform 110 are described with reference to FIG. 1B.

The enterprise application host platform 120 may comprise one or more computing devices and/or other computer components (e.g., processors, memories, communication interfaces). In addition, the enterprise application host platform 120 may be configured to host, execute, and/or otherwise provide one or more services/applications for the end-users. For example, if the computing environment 100 is associated with a financial institution, the enterprise application host platform 120 may be configured to host, execute, and/or otherwise provide one or more transaction processing programs (e.g., online banking applications, fund transfer applications, electronic trading applications), applications for generation of regulatory reports, and/or other programs associated with the financial institution. As another example, if the computing environment 100 is associated with an online streaming service, the enterprise application host platform 120 may be configured to host, execute, and/or otherwise provide one or more programs for storing and providing streaming content to end-user devices. The above are merely exemplary use-cases for the computing environment 100, and one of skill in the art may easily envision other scenarios where the computing environment 100 may be utilized to provide and support end-user applications.

The enterprise user computing device(s) 115 may be personal computing devices (e.g., desktop computers, laptop computers) or mobile computing devices (e.g., smartphones, tablets). In addition, the enterprise user computing device(s) 115 may be linked to and/or operated by specific enterprise users (who may, for example, be employees or other affiliates of the enterprise organization). An authorized user (e.g., an employee) may use an enterprise user computing device 115 to develop, test and/or support services/applications provided by the enterprise organization. The enterprise user computing device(s) 115 may download neural network models from the online repository 125 for local usage and/or usage within the private network 130. Further, the enterprise user computing device(s) 115 may have and/or access tools/applications to operate and/or train neural network models for various services/applications provided by the enterprise organization.

The computing device(s) 140 may be personal computing devices (e.g., desktop computers, laptop computers) or mobile computing devices (e.g., smartphones, tablets). An authorized user (e.g., an end-user) may use a computing device 140 to access services/applications provided by the enterprise organization, or to submit service requests and/or incident reports associated with any of the services/applications.

The online repository 125 may comprise neural network models as stored at a network accessible database. The neural network models may comprise algorithms, architecture, model parameters (e.g., weights and biases), etc., as may have been submitted/uploaded by various users connected to the private network 130 and/or the public network 135. The neural network models may be generated by the machine learning platform 110 based on various training procedures described herein. In an arrangement, an architecture of a neural network may indicate one or more of a number of input nodes, a number of output nodes, a number of intermediary nodes in each layer of the neural network, interconnections between the nodes, etc., of the neural network. Other users (e.g., associated with computing device(s) 140 and/or the enterprise user computing device(s) 115) may download the neural network models for use on a computing device. The online repository may be associated with one or more of volatile and nonvolatile, removable and non-removable media implemented in any method or technology for storage of information such as computer readable instructions, data structures, program modules and/or other data. Computer-readable storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium.

In one or more arrangements, the machine learning platform 110, the online repository 125, the enterprise user computing device(s) 115, the enterprise application host platform 120, the computing device(s) 140, and/or the other devices/systems in the computing environment 100 may be any type of computing device capable of receiving input via a user interface, and communicating the received input to one or more other computing devices in the computing environment 100. For example, the machine learning platform 110, the online repository 125, the enterprise user computing device(s) 115, the enterprise application host platform 120, the computing device(s) 140, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the machine learning platform 110, the online repository 125, the enterprise user computing device(s) 115, the enterprise application host platform 120, the computing device(s) 140, and/or the other devices/systems in the computing environment 100 may, in some instances, be and/or comprise special-purpose computing devices configured to perform specific functions.

FIG. 1B shows an example machine learning platform 110, in accordance with one or more examples described herein. The machine learning platform 110 may comprise one or more of host processor(s) 166, medium access control (MAC) processor(s) 168, physical layer (PHY) processor(s) 170, transmit/receive (TX/RX) module(s) 172, memory 160, and/or the like. One or more data buses may interconnect host processor(s) 166, MAC processor(s) 168, PHY processor(s) 170, and/or Tx/Rx module(s) 172, and/or memory 160. The machine learning platform 110 may be implemented using one or more integrated circuits (ICs), software, or a combination thereof, configured to operate as discussed below. The host processor(s) 166, the MAC processor(s) 168, and the PHY processor(s) 170 may be implemented, at least partially, on a single IC or multiple ICs. Memory 160 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 168 and/or the PHY processor(s) 170 of the machine learning platform 110 may be configured to generate data units, and process received data units, that conform to any suitable wired and/or wireless communication protocol. For example, the MAC processor(s) 168 may be configured to implement MAC layer functions, and the PHY processor(s) 170 may be configured to implement PHY layer functions corresponding to the communication protocol. The MAC processor(s) 168 may, for example, generate MAC data units (e.g., MAC protocol data units (MPDUs)), and forward the MAC data units to the PHY processor(s) 170. The PHY processor(s) 170 may, for example, generate PHY data units (e.g., PHY protocol data units (PPDUs)) based on the MAC data units. The generated PHY data units may be transmitted via the TX/RX module(s) 172 over the private network 130. Similarly, the PHY processor(s) 170 may receive PHY data units from the TX/RX module(s) 172, extract MAC data units encapsulated within the PHY data units, and forward the extracted MAC data units to the MAC processor(s). The MAC processor(s) 168 may then process the MAC data units as forwarded by the PHY processor(s) 170.

One or more processors (e.g., the host processor(s) 166, the MAC processor(s) 168, the PHY processor(s) 170, and/or the like) of the machine learning platform 110 may be configured to execute machine readable instructions stored in memory 160. The memory 160 may comprise one or more program modules/engines having instructions that when executed by the one or more processors cause the machine learning platform 110 to perform one or more functions described herein. The one or more program modules/engines and/or databases may be stored by and/or maintained in different memory units of the machine learning platform 110 and/or by different computing devices that may form and/or otherwise make up the machine learning platform 110. For example, the memory 160 may have, store, and/or comprise clustering module(s) 161, neural network module(s) 162 and/or a training database 164.

The clustering module(s) 161 may comprise instructions/algorithms that may cause the machine learning platform 110 to perform clustering operations on a training dataset as stored in the training database 164. For example, the clustering operations may comprise performing non-supervised machine learning operations on the training dataset to categorize the training dataset into a plurality of groups.

The machine learning module(s) 162 may have instructions/algorithms that may cause the machine learning platform 110 to implement machine learning processes in accordance with the examples described herein. For example, the machine learning module(s) 163 may comprise instructions for (re)training a neural network model (e.g., using the training database 164) and/or modifying an architecture/parameters of the neural network model in accordance with the various examples described herein. The training database 164 may comprise various test input and output data that may be used for (re)training a neural network model.

While FIG. 1A illustrates the machine learning platform 110, the enterprise user computing device(s) 115, the enterprise application host platform 120, and the online repository 125 as being separate elements connected in the private network 130, in one or more other arrangements, functions of one or more of the above may be integrated in a single device/network of devices. For example, elements in the machine learning platform 110 (e.g., host processor(s) 166, memory(s) 160, MAC processor(s) 168, PHY processor(s) 170, TX/RX module(s) 172, and/or one or more program/modules stored in memory(s) 160) may share hardware and software elements with and corresponding to, for example, the enterprise application host platform 120 and/or the enterprise user devices 115.

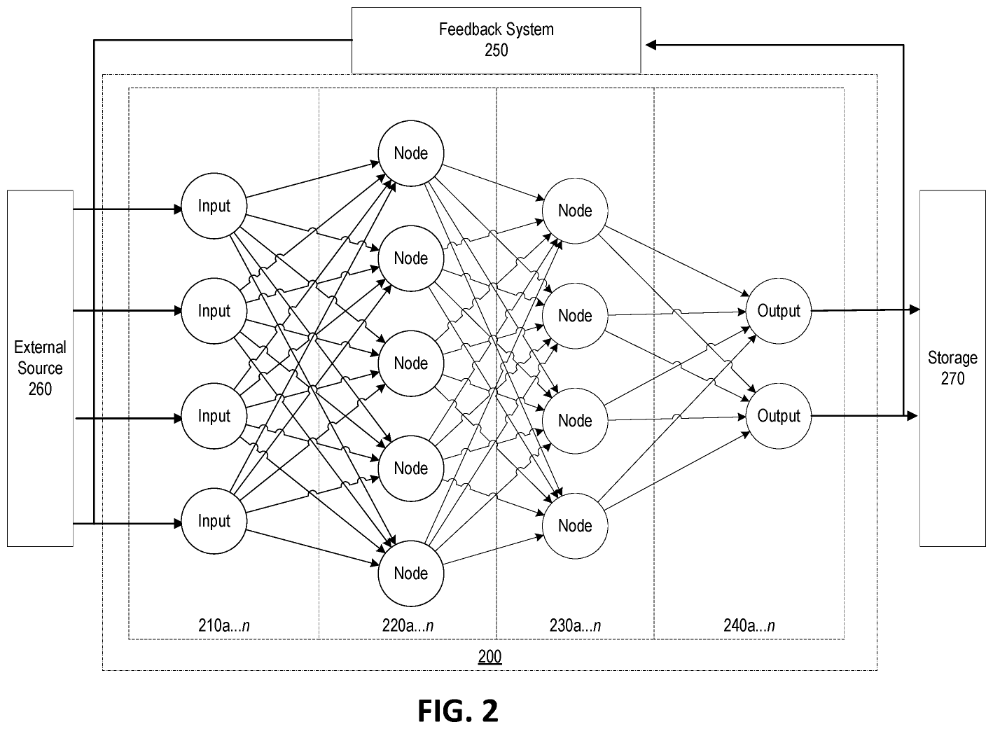

FIG. 2 shows a simplified example of an artificial neural network 200 on which a machine learning algorithm may be executed, in accordance with one or more example arrangements. The machine learning algorithm may be in accordance with the instructions stored in the neural network module(s) 162 for performing one or more functions of the machine learning platform 110, as described herein. In some arrangements, the machine learning algorithm may be in accordance with instructions stored in one or more other devices, configured to use the neural network 200, of the computing environment 100. The machine learning algorithm is merely an example of nonlinear processing using an artificial neural network; other forms of nonlinear processing may be used to implement a machine learning algorithm in accordance with features described herein.

In one example, a framework for a machine learning algorithm may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks. Such structures, while significantly more complex than conventional computer systems, are beneficial in implementing machine learning. For example, an artificial neural network may be comprised of a large set of nodes which, like neurons, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator.

Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 2000 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”).

One theory underlying supervised learning is inductive learning. In inductive learning, a data representation is provided as input samples data (x) and output samples of the function (f(x)). The goal of inductive learning is to learn a good approximation for the function for new data (x), i.e., to estimate the output for new input samples in the future. Inductive learning may be used on functions of various types: (1) classification functions where the function being learned is discrete; (2) regression functions where the function being learned is continuous; and (3) probability estimations where the output of the function is a probability.

In practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (1) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

By way of example, in FIG. 2, each of input nodes 210a-n is connected to a first set of processing nodes 220a-n. Each of the first set of processing nodes 220a-n is connected to each of a second set of processing nodes 230a-n. Each of the second set of processing nodes 230a-n is connected to each of output nodes 210a-n. Though only two sets of processing nodes are shown, any number of processing nodes may be implemented. Similarly, though only four input nodes, five processing nodes, and two output nodes per set are shown in FIG. 2, any number of nodes may be implemented per set. Data flows in FIG. 2 are depicted from left to right: data may be input into an input node, may flow through one or more processing nodes, and may be output by an output node. Input into the input nodes 210a-n may originate from an external source 260.

In one illustrative method using feedback system 250, the system may use machine learning to determine an output. The system may use one of a myriad of machine learning models including xg-boosted decision trees, auto-encoders, perceptron, decision trees, support vector machines, regression, and/or a neural network. The neural network may be any of a myriad of type of neural networks including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality. Output may be sent to a feedback system 250 and/or to storage 270.

In an arrangement where the neural network 200 is used for character recognition, the input from the input nodes may be raw data comprising pixel values of handwritten characters as written by a user, and the output from the output nodes may be an indication of the character as determined by the neural network (e.g., an indication of whether the character is ‘1’, ‘2’, ‘a’, ‘A’, etc.). In an arrangement where the neural network 200 is used for object recognition, the input from the input nodes may be raw data comprising pixel values of each pixel comprising an image, and the output from the output nodes may be a label/description of an object corresponding to/shown in the image. For example, the neural network may be trained to identify whether an image contains one or more of a specific set of items (e.g., a show, a ball, a tree, a car, a book, a smartphone, etc.). In this case, the output may be a text output describing the object shown in the image.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tanh function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting—regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (1) optimizing a sampling method, such as using a stochastic gradient descent (SGD) method where instead of feeding an entire dataset to the machine learning algorithm for the computation of each step, a subset of data is sampled sequentially.

In one example, FIG. 2 depicts nodes that may perform various types of processing, such as discrete computations, computer programs, and/or mathematical functions implemented by a computing device. For example, the input nodes 210a-n may comprise logical inputs of different data sources, such as one or more data servers. The processing nodes 220a-n may comprise parallel processes executing on multiple servers in a data center. And, the output nodes 240a-n may be the logical outputs that ultimately are stored in results data stores, such as the same or different data servers as for the input nodes 210a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 200 may learn and/or be dynamically reconfigured. Though nodes are depicted as having connections only to successive nodes in FIG. 1, connections may be formed between any nodes. For example, one processing node may be configured to send output to a previous processing node.

Input received in the input nodes 210a-n may be processed through processing nodes, such as the first set of processing nodes 220a-n and the second set of processing nodes 230a-n. The processing may result in output in output nodes 240a-n. As depicted by the connections from the first set of processing nodes 220a-n and the second set of processing nodes 230a-n, processing may comprise multiple steps or sequences. For example, the first set of processing nodes 220a-n may be a rough data filter, whereas the second set of processing nodes 230a-n may be a more detailed data filter.

The artificial neural network 200 may be configured to effectuate decision-making. As a simplified example for the purposes of explanation, the artificial neural network 200 may be configured to detect faces in photographs. The input nodes 210a-n may be provided with a digital copy of a photograph. The first set of processing nodes 220a-n may be each configured to perform specific steps to remove non-facial content, such as large contiguous sections of the color red. The second set of processing nodes 230a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 200 may then predict the location on the face. The prediction may be correct or incorrect.

The feedback system 250 may be configured to determine whether or not the artificial neural network 200 made a correct decision. Feedback may comprise an indication of a correct answer and/or an indication of an incorrect answer and/or a degree of correctness (e.g., a percentage). For example, in the facial recognition example provided above, the feedback system 250 may be configured to determine if the face was correctly identified and, if so, what percentage of the face was correctly identified. The feedback system 250 may already know a correct answer, such that the feedback system may train the artificial neural network 200 by indicating whether it made a correct decision. The feedback system 250 may comprise human input, such as an administrator telling the artificial neural network 200 whether it made a correct decision. The feedback system may provide feedback (e.g., an indication of whether the previous output was correct or incorrect) to the artificial neural network 200 via input nodes 210a-n or may transmit such information to one or more nodes. The feedback system 250 may additionally or alternatively be coupled to the storage 270 such that output is stored. The feedback system may not have correct answers at all, but instead base feedback on further processing: for example, the feedback system may comprise a system programmed to identify faces, such that the feedback allows the artificial neural network 200 to compare its results to that of a manually programmed system.

The artificial neural network 200 may be dynamically modified to learn and provide better input. Based on, for example, previous input and output and feedback from the feedback system 250, the artificial neural network 200 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 200, such that the artificial neural network 200 may vary its nodes and connections to test hypotheses.

The artificial neural network 200 need not have a set number of processing nodes or number of sets of processing nodes, but may increase or decrease its complexity. For example, the artificial neural network 200 may determine that one or more processing nodes are unnecessary or should be repurposed, and either discard or reconfigure the processing nodes on that basis. As another example, the artificial neural network 200 may determine that further processing of all or part of the input is required and add additional processing nodes and/or sets of processing nodes on that basis.

The feedback provided by the feedback system 250 may be mere reinforcement (e.g., providing an indication that output is correct or incorrect, awarding the machine learning algorithm a number of points, or the like) or may be specific (e.g., providing the correct output). For example, the machine learning algorithm 200 may be asked to detect faces in photographs. Based on an output, the feedback system 250 may indicate a score (e.g., 75% accuracy, an indication that the guess was accurate, or the like) or a specific response (e.g., specifically identifying where the face was located).

In an exemplary neural network, an output from an output node may be expressed as a function of an input at the plurality of input nodes. For example, if the outputs from the first set of processing nodes 220a-n are represented as bₐ, b_{b} . . . bₙ and inputs from the input nodes 210a-n is represented as aₐ, a_{b} . . . aₙ, a value of an output node bₙ may be represented as:

bₙ=A(aₐwₐ+aₐw_{b}+ . . . aₙwₙ−x) Equation (1)

where A is the activation function, wₐ, w_{b} . . . wₙ are the weights applied to at the input nodes 210a-n, and x is a bias value applied to the function. Each output bₐ, b_{b} . . . bₙ from the first set of processing nodes may be similarly processed at the second set of processing nodes, each of which may be associated with its own set of biases and weights. Processing, in this manner at each of layers of intermediary nodes, outputs may be generated at the output nodes 240a-n. Training a neural network, as described above, comprises setting optimal values of weights and biases to achieve a required level of accuracy for a given function of the neural network. Weights and biases of the neural network may be referred to as model parameters of the neural network.

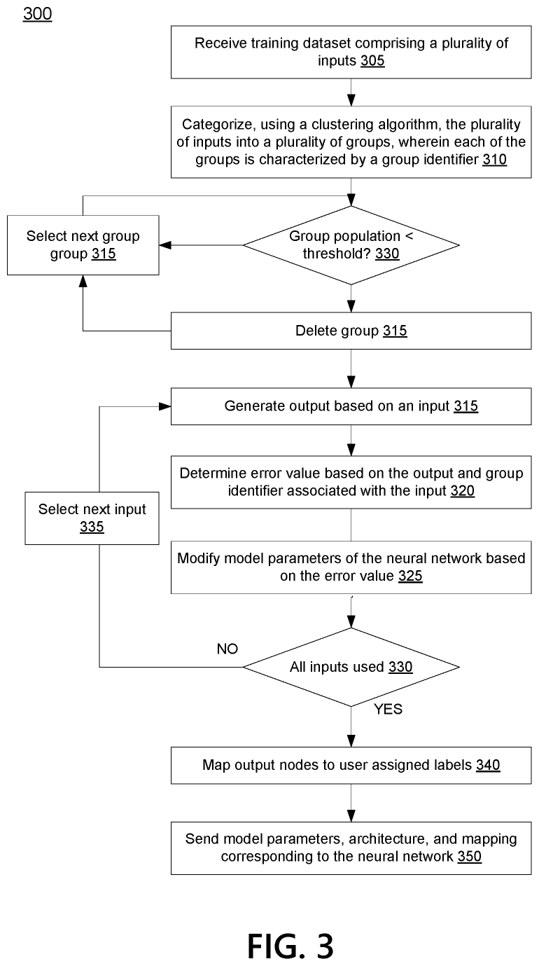

FIG. 3 shows an example algorithm 300 for training a neural network, in accordance with one or more example arrangements. Training dataset for the neural network may be processed using a clustering algorithm to generate machine-assigned clusters, each comprising one or more inputs of the training dataset. This may ensure a more accurate training for the neural network. In an arrangement, the machine learning platform 110 may perform the various steps as shown in FIG. 3.

At step 305, the machine learning platform 110 may receive/determine a training dataset for training a neural network. The training dataset may comprise a plurality of inputs. The machine learning platform 110 may further receive/determine an architecture (e.g., number of input nodes, a number of output nodes, a number of intermediary nodes, etc.) of the neural network. In an arrangement, the machine learning platform 110 may receive/determine the training dataset from the training database 164. In an arrangement, the machine learning platform 110 may receive/determine the architecture of the neural network via user input at the enterprise user computing device 115 or the computing device 140.

In an arrangement where the neural network is for identification of handwritten digits, the training dataset may comprise a plurality of handwritten digits (e.g., 0, 1, 2, . . . 9) in one or more appropriate file formats (e.g., .jpg, .tiff, .bmp, etc.). Inputs to each of the input nodes may comprise pixel values of handwritten characters. In an arrangement where the neural network is for image recognition, the training dataset may comprise a plurality of images in one or more appropriate file formats. Inputs to each of the input nodes may comprise pixel values of the images. While the various examples herein relate to training neural networks used for image analysis/classification, the procedure of FIG. 3 may be used for any application of neural networks.

At step 310, the machine learning platform 110 may categorize, using an unsupervised algorithm (e.g., a clustering algorithm), the plurality of inputs into a plurality of groups. For example, and if the training dataset comprises handwritten digits, each of the plurality of groups may comprise digits that look most “similar” to each other. Each of the groups may be assigned a corresponding group identifier (e.g., a numeric code). The clustering algorithm may comprise one or more of hierarchical clustering, centroid-based clustering, density-based clustering, and/or distribution-based clustering. While the various examples herein refer to the use of a clustering algorithm for categorizing the plurality of inputs into different groups, any unsupervised machine learning algorithm may be used instead without departing from the scope of this invention.

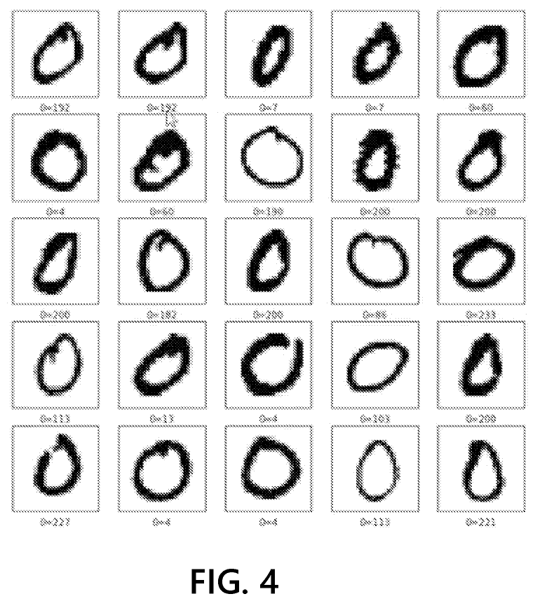

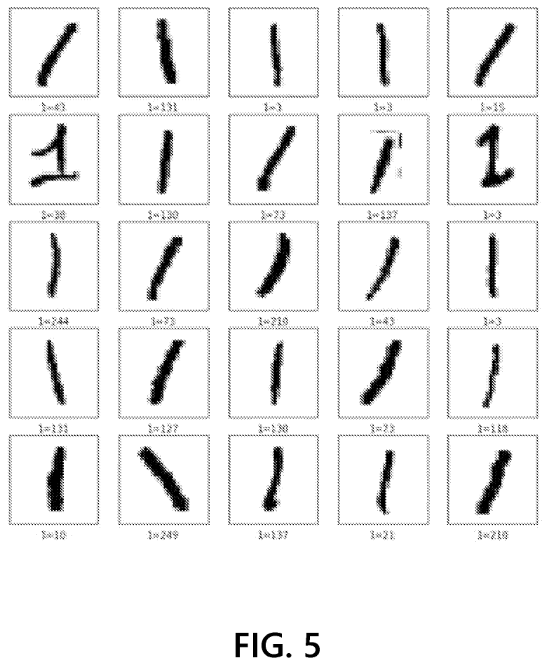

FIGS. 4 and 5 shows example training dataset input of some handwritten digits corresponding to ‘0’ and ‘1’. The labels under each of the digits correspond to groups to which a particular digit has been assigned by the clustering algorithm. The labels assigned by the clustering algorithm are also referred to herein as group identifiers. The group identifiers may be used as the expected outputs corresponding to the training inputs for training the neural network.

The machine learning platform 110 may provide an input, of the plurality of inputs, to a plurality of input nodes of the neural network. At step 315, and based on the input, the neural network may generate an output at one or more output nodes of the neural network. At step 320, the machine learning platform 110 may determine an error value for the input. The error value may be determined based on the input, the generated output, an expected output for the input (e.g., the group identifier for the input), and a loss function. If the neural network is to be used for categorization/classification purposes (e.g., identification of a handwritten digit, or an image), the neural network may be trained such that an output node corresponding to a category of the input (e.g., a group identifier of the input) is activated (e.g., shows the highest value). For example, if the neural network is to be used for identification of handwritten digits, the neural network may be trained such that an output node corresponding to a group identifier of a detected digit is activated (e.g., shows the highest value).

As explained later, the group identifier may then be mapped to human-labeled category which may be considered as the final output of the machine learning algorithm. It should be noted that the clustering algorithm is not employed during the actual use for categorization, but is only employed for processing training data to determine group identifiers for training the neural network.

Various types of loss functions may be used based on a function of the neural network. For example, a binary cross-entropy function may used if the neural network is for a binary classification purpose (e.g., if the neural network is for determine one of two possible outcomes for a given input). A categorical cross-entropy function may be used if the neural network is for a multiclass classification purpose (e.g., if the neural network is for determine one of multiple possible outcomes for a given input). A mean squared error loss function may be used to if the neural network is for generating a single output value for a given input. Any other type of loss function may be used. The error value may be used to update the model parameters (e.g., weights and/or biases) of the neural network. With respect to the example where the neural network is for identification of handwritten digits, a categorical cross-entropy function may be used as the loss function.

Some groups may have populations (e.g., numbers of inputs assigned to the groups) that are small or non-significant. These groups may comprise input data that may be considered outliers for training purposes. As such assigning output nodes for processing/indicating these outliers may be considered inefficient for training purposes.

At step 325, the machine learning platform 110 may update the model parameters (e.g., weights and biases) of the neural network based on the error value. The machine learning platform 110 may use, for example, a gradient descent algorithm to update the weights and biases of the neural network.

At step 330, the machine learning platform 110 may determine whether all inputs in the training dataset have been used for training the neural network. If additional inputs and corresponding group identifiers as determined by the clustering algorithm are available in the training dataset, the machine learning platform 110 may (e.g., step 335) select the input and repeat steps 315, 320 and 325.

In this manner, the output nodes may be trained to determine a group identifier that an input may be associated to. For example, during use, if an input image is determined by the neural network as corresponding to group identifier 192 (e.g., digit ‘0’ as shown in FIG. 4), an output node corresponding to the group identifier 192 is activated (e.g., has the highest value among all output nodes). Similarly, if an input image is determined by the neural network as corresponding to group identifier 3 (e.g., digit ‘1’ as shown in FIG. 5), an output node corresponding to the group identifier 3 is activated (e.g., has the highest value among all output nodes). However, the neural network is still only trained by the training dataset and the clustering algorithm to identify a group identifier for an input. Therefore, the output nodes need to be mapped to final labels that the inputs may correspond to. With respect to the above example, the output node corresponding to the group identifier 192 needs to be mapped to the label ‘0’ and the output node corresponding to the group identifier 3 needs to be mapped to the label ‘1’.

At step 340, the output nodes of the neural network may be mapped to human-assigned labels. The mapping between the output nodes and the human-assigned labels may be based on the clustering results, and human interpretation of the clustering results and may be stored in a dictionary at the machine learning platform 110. A user may review the clustering results (e.g., as shown in FIGS. 4 and 5 for handwritten digit identification) and map the output nodes corresponding to each of the group identifiers to respective digits.

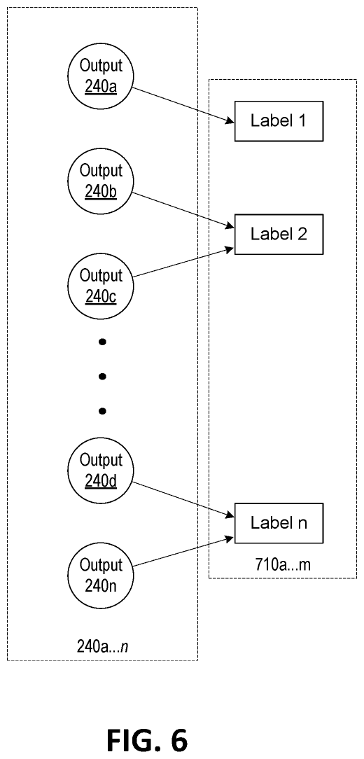

In an arrangement where the neural network is for image recognition, each of the output nodes may correspond to a specific group identifier that the neural network is trained to identify based on an input image. Activation of an output node corresponding to a specific group identifier may imply that the neural network has detected an image corresponding to that group identifier. With respect to FIG. 5, for example, an output node corresponding to one of the group identifiers 192, 7, 60, 200, etc., being activated based on an input image may imply that the handwritten digit corresponds to ‘0’. Therefore, nodes corresponding to group identifiers 192, 7, 60, 200, etc. may all be mapped to human-assigned label/digit ‘0’. Similarly, and with respect to FIG. 6, for example, an output node corresponding to one of the group identifiers 43, 131, 3, 73, etc., being activated based on an input image may imply that the handwritten digit corresponds to ‘1.’ Therefore, nodes corresponding to group identifiers 43, 131, 3, 73, etc. may all be mapped to human-assigned label/digit ‘1’.

FIG. 6 shows an example mapping between output nodes 240a . . . n and human-assigned labels 710a . . . m, in accordance with one or more example arrangements. In this example, activation of output node 240a may result in the neural network categorizing the input as corresponding to label 1. Activation of any one of the output nodes 240b and 240c may result in the neural network categorizing the input as corresponding to label 2. Activation of any one of the output nodes 240d and 240n may result in the neural network categorizing the input as corresponding to label n.

At step 350, the machine learning platform 110 may send indications of the determined model parameters (e.g., weights, biases), neural network architecture, and the mapping to one or more computing devices in the computing environment 100. For example, the machine learning platform 110 may send the indications of the determined model parameters, neural network architecture, and the mapping to the online repository 125 for storage. The machine learning platform 110 may send the indications of the determined model parameters, neural network architecture, the mapping to the enterprise user computing device 115 or the computing device 140. The enterprise user computing device 115 or the computing device 140 may then use the neural network.

Use of labels generated using a clustering algorithm rather than just human-assigned labels for training the neural network allows the neural network to use actual machine understandable outputs as expected outputs for training purposes. This may improve neural network accuracy by the use of labels as estimated by a machine (what it actually “sees”) rather than what a human sees. This bridges the gap between computer vision and human vision for labeling training datasets.

Further, the clustering algorithm results in the use of increased number of labels for higher granularity. For example, human labeled training data for handwritten digit recognition may only comprise 10 labels (0-9), while labels given by a clustering algorithm (e.g., group identifiers) may number in the hundreds. This may enable flexibility by accounting for variations in the images that should otherwise correspond to a same category (e.g., a same digit). For example, there may variations in the manner in which certain digits are written across different countries, which may sometimes be hard for traditionally-trained neural networks to detect.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising
a processor; and
memory storing computer-readable instructions that, when executed by the processor, cause the computing platform to:
receive, from a training database, a training dataset comprising a plurality of inputs for a neural network;
categorize, using a clustering algorithm, the plurality of inputs into a plurality of groups, wherein each of the groups is characterized by a group identifier;
iteratively train, based on the plurality of inputs and group identifiers associated with the plurality of inputs, the neural network, wherein the training comprises:
providing an input of the plurality of inputs, to a plurality of input nodes of the neural network,
generating, from a plurality of output nodes, an output based on the input,
determining an error value based on the output, a group identifier associated with the input, and a loss function, and
based on the error value, modifying one or more model parameters of the neural network;
map each of the plurality of output nodes of the neural network to corresponding user-assigned labels; and
send, to a user computing device, the model parameters of the neural network and the mapping between the plurality of output nodes of the neural network and the user-assigned labels.

2. The computing platform of claim 1, wherein the neural network is for classifying an input as corresponding to one of the user-assigned labels.

3. The computing platform of claim 1, wherein the instructions, when executed by the processor, cause the computing platform to remove groups which comprise a number of inputs less than a threshold quantity.

4. The computing platform of claim 1, wherein the instructions, when executed by the processor, cause the computing platform to not use, for the training, groups which comprise a number of inputs less than a threshold quantity.

5. The computing platform of claim 4, wherein the threshold quantity is a fixed fraction of a quantity of the plurality of inputs.

6. The computing platform of claim 1, wherein a dictionary data store stores a mapping between each of the group identifiers and corresponding user-assigned labels, and wherein the mapping each of the plurality of output nodes of the neural network to corresponding user-assigned labels is based on the dictionary data store.

7. The computing platform of claim 1, wherein the plurality of inputs comprises machine-scanned handwritten characters and the user-assigned labels comprise descriptions of the characters.

8. The computing platform of claim 1, wherein the plurality of inputs comprises computer-readable bit patterns corresponding to the characters.

9. The computing platform of claim 1, wherein the plurality of inputs comprises images and the user-assigned labels correspond to descriptions associated with the images.

10. The computing platform of claim 1, wherein the loss function is one of:
a mean squared error loss function,
a binary cross-entropy loss function; or
a categorical cross-entry loss function.

11. The computing platform of claim 1, wherein the clustering algorithm comprises one or more of hierarchical clustering, centroid based clustering, density based clustering, or distribution based clustering.

12. A method comprising:
receiving, from a training database, a training dataset comprising a plurality of inputs for a neural network;
categorizing, using a clustering algorithm, the plurality of inputs into a plurality of groups, wherein each of the groups is characterized by a group identifier;
iteratively training, based on the plurality of inputs and group identifiers associated with the plurality of inputs, the neural network, wherein the training comprises:
providing an input of the plurality of inputs, to a plurality of input nodes of the neural network,
generating, from a plurality of output nodes, an output based on the input,
determining an error value based on the output, a group identifier associated with the input, and a loss function, and
based on the error value, modifying one or more model parameters of the neural network;
mapping each of the plurality of output nodes of the neural network to corresponding user-assigned labels;
sending, to a user computing device, the model parameters of the neural network and the mapping between the plurality of output nodes of the neural network and the user-assigned labels.

13. The method of claim 12, wherein the neural network is for classifying an input as corresponding to one of the user-assigned labels.

14. The method of claim 12, further comprising removing groups which comprise a number of inputs less than a threshold quantity.

15. The method of claim 12, further comprising not using, for the training, groups which comprise a number of inputs less than a threshold quantity.

16. The method of claim 15, wherein the threshold quantity is a fixed fraction of a quantity of the plurality of inputs.

17. The method of claim 15, wherein a dictionary data store stores a mapping between each of the group identifiers and corresponding user-assigned labels, and wherein the mapping each of the plurality of output nodes of the neural network to corresponding user-assigned labels is based on the dictionary data store.

18. The method of claim 15, wherein the plurality of inputs comprises machine-scanned handwritten characters and the user-assigned labels comprise descriptions of the characters.

19. The method of claim 15, wherein the plurality of inputs comprises computer-readable bit patterns corresponding to the characters.

20. One or more non-transitory computer-readable media storing instructions that, when executed by a computer processor, cause a computing system to:
receive, from a training database, a training dataset comprising a plurality of inputs for a neural network;
categorize, using a clustering algorithm, the plurality of inputs into a plurality of groups, wherein each of the groups is characterized by a group identifier;
iteratively train, based on the plurality of inputs and group identifiers associated with the plurality of inputs, the neural network, wherein the training comprises:
providing an input of the plurality of inputs, to a plurality of input nodes of the neural network,
generating, from a plurality of output nodes, an output based on the input,
determining an error value based on the output, a group identifier associated with the input, and a loss function, and
based on the error value, modify one or more model parameters of the neural network;
map each of the plurality of output nodes of the neural network to corresponding user-assigned labels; and
send, to a user computing device, the model parameters of the neural network and the mapping between the plurality of output nodes of the neural network and the user-assigned labels.
